(19) United States
(12) Patent Application Publication
(10) Pub. No.: US 2012/0174010 A1
(43) Pub. Date: Jul. 5, 2012

(54) Media Content Flocking

(75) Inventors: Gary Flint, Cupertino, CA (US); Stefan Hafeneger, Elsdorf (DE)

(73) Assignee: APPLE INC., Cupertino, CA (US)

(21) Appl. No.: 12/983,739

(22) Filed: Jan. 3, 2011

(51) Int. Cl. G06F 3/048

(52) U.S. Cl. 715/769; 715/856

(57) ABSTRACT

Media content flocking is disclosed. According to implementations, a method can include displaying a first sequence of objects on a display of a computing device, receiving a selection of at least two non-adjacent objects from the first sequence, and animating the at least two non-adjacent objects to move along respective paths from the display of the first sequence to a current location of a cursor on the display. The objects in the first sequence can be video clips or other types of media, such as presentation slides, audio clips or any other media that can be manipulated in a timeline.

### TECHNICAL FIELD

The disclosure generally relates to graphical user interfaces and digital video editing.

### BACKGROUND

Video editing applications allow users to create, manipulate and aggregate video data. Vendors of video editing applications often seek to provide a user interface that makes video editing applications easy to use. Often vendors attempt to provide an interface with a look and feel that a user may enjoy.

### SUMMARY

Media content flocking is disclosed. According to implementations, a method can include displaying a first sequence of objects on a display of a computing device, receiving a selection of at least two non-adjacent objects from the first sequence, and animating the at least two non-adjacent objects to move along respective paths from the display of the first sequence to a current location of a cursor on the display. The objects in the first sequence can be video clips or other types of media, such as presentation slides, audio clips or any other media that can be manipulated in a timeline.

According to implementations, the method can include displaying a preview sequence of the at least two non-adjacent objects at the current location of a cursor. Some implementations provide that while moving the cursor on the display, the preview sequence is moved proximate to the cursor. The at least two non-adjacent objects can be displayed in the preview sequence contiguously and in the same relative order as they were displayed in the first sequence.

According to implementations, the method can include receiving input indicating a position in the first sequence; moving the at least two non-adjacent objects to the position in the first sequence to change the order of the objects in the first sequence; and displaying the changed first sequence of objects.

According to an implementation, the method can include receiving input that causes displaying the cursor and the preview sequence hovering over a position in the first sequence, and responsive to the input, displaying an empty space at the position in the first sequence, the empty space having a width that corresponds to a length of the preview sequence.

According to implementations, the method can include performing a drag operation that causes two or more images corresponding to the at least two non-adjacent objects in the first sequence to move from the display of the first sequence to the current location of the cursor on the display. The method can include performing a drag-and-drop operation that causes two or more images corresponding to the at least two non-adjacent objects displayed at the current location of the cursor to move from the current location of the cursor to an indicated location in the first sequence. The drag and drop operation can cause the at least two non-adjacent objects to move from their previous locations in the first sequence to adjacent positions at the indicated location in the first sequence. The drag-and-drop operation can be used to generate a reordered first sequence.

A system and computer-readable storage medium for performing the method above are also disclosed.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates an exemplary video playback user interface.

FIG. 2 illustrates an exemplary video editing user interface.

FIG. 3 illustrates selecting multiple video clips from a timeline.

FIG. 4 illustrates video clip flocking.

FIG. 5A illustrates expanding a space in the timeline to accommodate selected video clips.

FIG. 5B illustrates inserting selected video clips into a new position in the timeline.

FIG. 6 is a block diagram of an exemplary video clip flocking system.

FIG. 7 is a flow diagram of an exemplary video clip flocking process.

FIG. 8 is a block diagram of an exemplary system architecture implementing the features and processes of FIGS. 1-7.

Like reference symbols in the various drawings indicate like elements.

### DETAILED DESCRIPTION

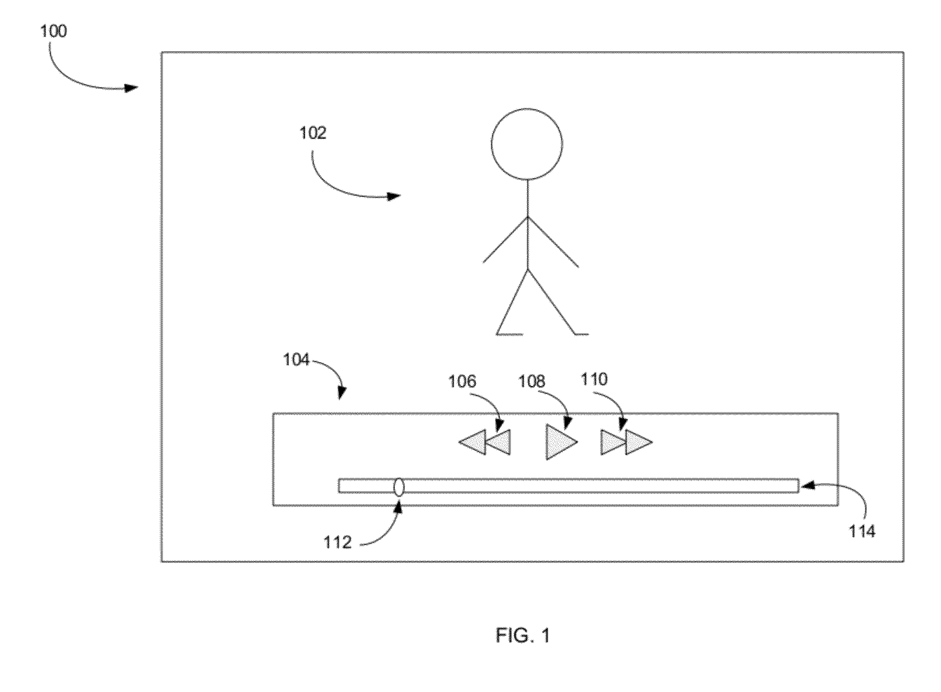

FIG. 1 illustrates an exemplary video playback user interface of a video editing application. The video playback user interface includes display environment 100. For example, display environment 100 may be an application window displayed on a display of a computing device. The display environment may be configured to display an image 102. For example, the image 102 may be a video image having successive frames of video clips or a still image such as a digital photograph. Control element 104 includes user interface elements 106, 108 and 110 for controlling the display of video. For example, element 106 allows a user to rewind (move the video back in time) a video, element 108 allows a user to play a video, and element 110 allows a user to fast forward a video. Control element 104 may also include timeline 114 to indicate to a user the duration of a video, how much of the video has been played, or how much of the video remains to be played. Timeline 114 may include position indicator 112 to indicate to a user the current position in the timeline during playback of a video. The video playback interface may also provide a user interface element (not shown) for entering an edit mode of the video editing application. For example, a user may enter an edit mode of the video editing application by selecting a menu item from a typical pull-down menu or by selecting a user interface element displayed in display environment 100 or displayed on control element 104.

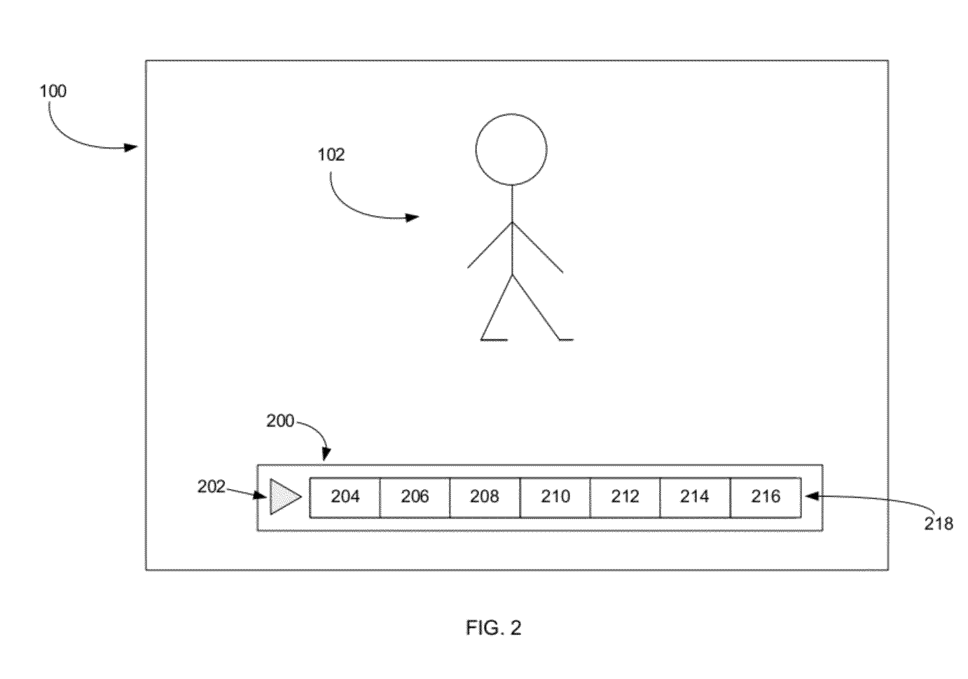

FIG. 2 illustrates an exemplary video editing user interface of a video editing application. The display environment 100 may include control element 200. For example, control element 200 may be displayed when the video editing application is in an edit mode. Control element 200 may be a semi-transparent overlay control element that allows a user to see the displayed image 102 through the control element 200. Control element 200 may include user interface element 202 that allows a user to play a video and a timeline 218 that displays images representing portions of a video 204-216 (video clips). Thus, the video includes the sequence of video clips 204-216 in timeline 218. Implementations disclosed herein allow a user to reorder the sequence of video clips 204-216 within timeline 218 by allowing the user to manipulate images that represent each video clip in the display environment 100.

According to implementations, the video editing application may be configured so that video clips may be added to timeline 218 by performing a drag and drop operation on a video clip. For example, a video clip outside of display environment 100 (e.g., external to the video editing application) may be selected by a user, dragged to a location in timeline 218, and dropped at the location into the sequence of video clips 204-216. If no video clips exist in the timeline, the external video clip is added to timeline 218. Video clips already in timeline 218 may be rearranged or removed through drag and drop operations. For example, a user may select a clip in timeline 218 and drag it to a different location in timeline 218 to modify the sequence of video clips 204-216. To remove video clips from timeline 218, the user may select one or more video clips and delete the selected video clips via a menu item (such as a delete menu item in a pull-down menu) or a keyboard key (such as a delete or backspace key).

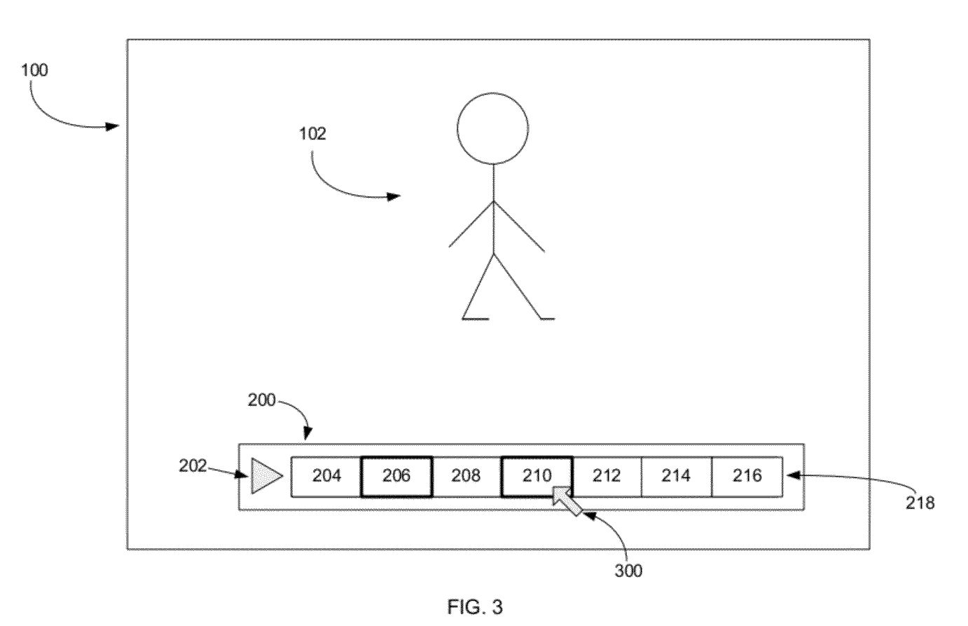

FIG. 3 illustrates selecting multiple video clips from a timeline in a video editing application. Multiple video clips may be selected from timeline 218. For example, highlighted video clips 206 and 210 may be selected so that operations may be performed on both clip 206 and clip 210 at the same time. Multiple clips may be selected by a user using cursor 300. For example, a user may position cursor 300 over clip 206 and provide a cursor input (e.g., click of a mouse, touch of a touch pad or touch screen, etc.) indicating that the user would like to select clip 206. The appearance of clip 206 can be changed to indicate its selection status. The user may then position cursor 300 over clip 210 and provide input indicating that the user would like to select clip 210 in addition to selecting clip 206. For example, to indicate a multiple selection of clip 206 and clip 210 a user may press and hold a key (e.g., command key, shift key, control key, etc.) on a keyboard in addition to providing the cursor input. Once clip 206 and clip 210 have been selected, a user may perform video editing operations on the multiple selected video clips.

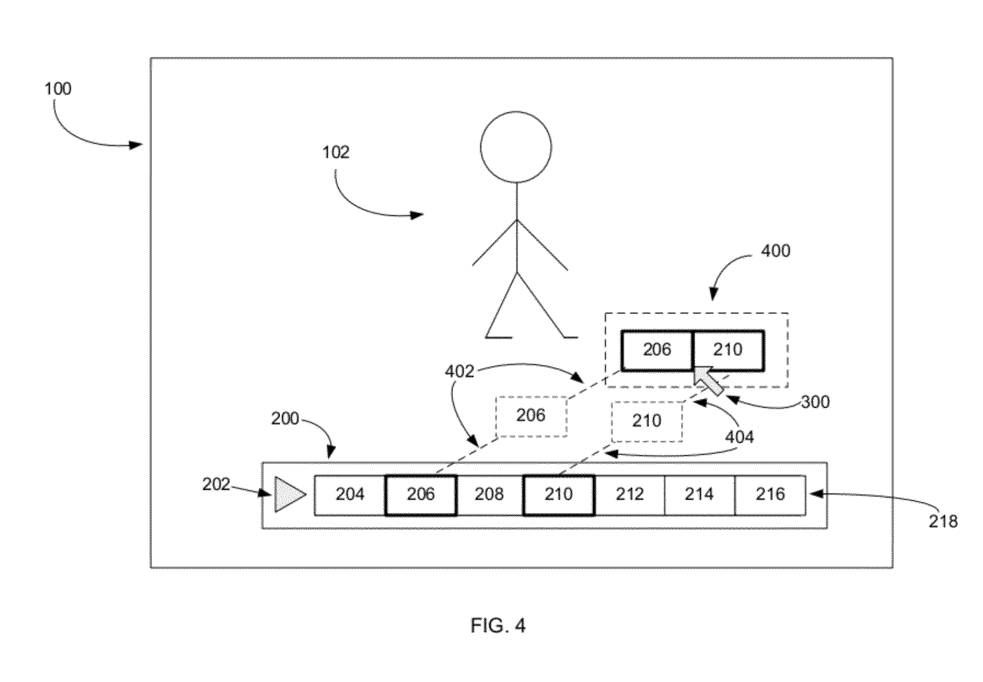

FIG. 4 illustrates video clip flocking. Flocking, or gathering of user interface elements, may be employed to improve the user experience in a video editing application. For example, a sequence of clips, 204-216, may be in a video being edited. A user may select non-adjacent clips 206 and 210, and then drag the selected clips out of their current locations in timeline 218. According to implementations, when dragged with the cursor, the clips may “flock” together (move closer to one another) as they move to cursor 300. For example, clips 206 and 210 may move to cursor 300 along respective paths 402 and 404 (or the same path) and be displayed at the location of cursor 300 as video clip preview 400. Thus, a user may observe images representing clips 206 and 210 moving across a display from their respective locations in timeline 218 to a location of cursor 300 on the display.

A video clip preview may be presented to a user to provide a contextual preview of the selected video clips. For example, clip 206 and clip 210 may be displayed in preview 400 as a contiguous sequence of video clips. Clip 206 and clip 210 may be positioned in preview 400 in the same relative order in which they were positioned in timeline 218. The video clip preview 400 may be moved about display environment 100 using cursor 300. For example, a user may move cursor 300 around display environment 100 and the video clip preview 400 may move proximate to cursor 300 such that cursor 300 and the video clip preview 400 appear to move together.

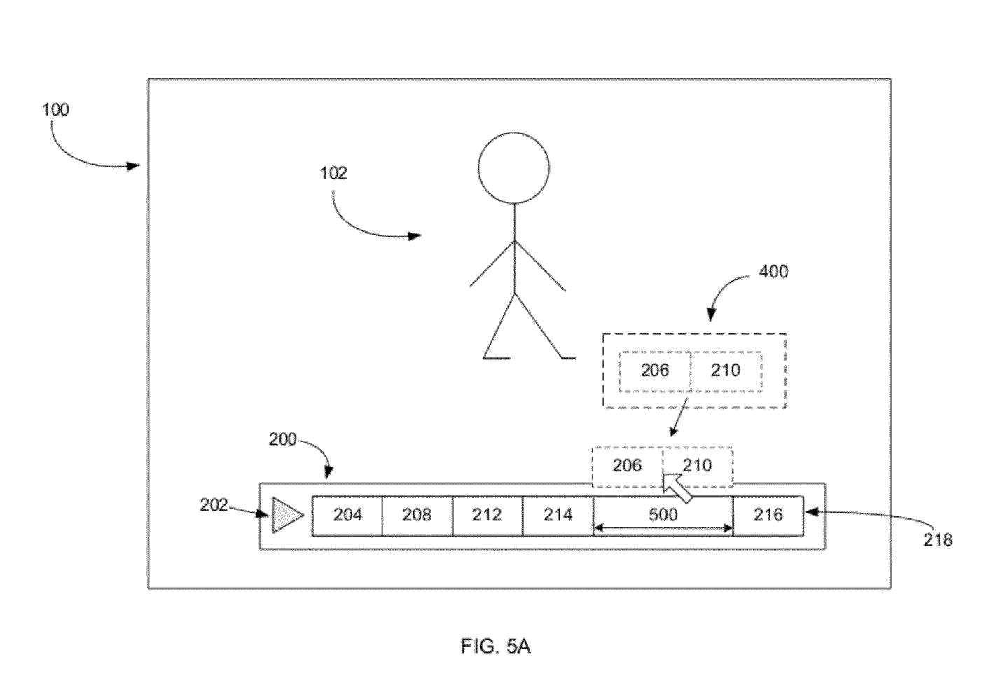

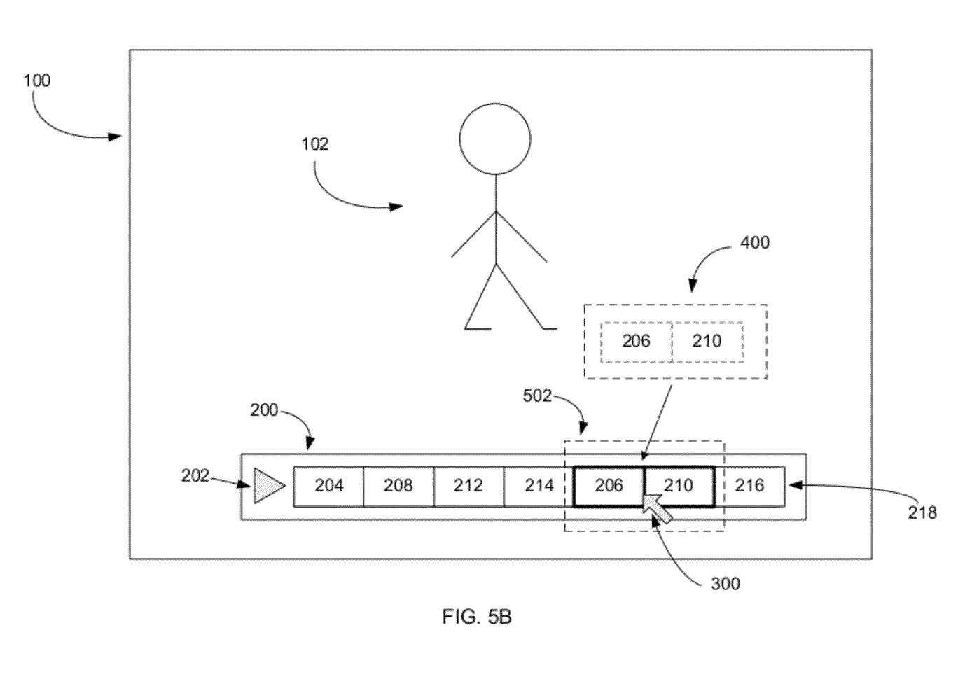

FIG. 5A illustrates expanding a space in a timeline to accommodate selected video clips. According to an implementation, a contextual preview of selected video clips is provided that allows selected clips to be treated as a single clip. For example, if the user drags clip 206 and clip 210 between clip 214 and clip 216 and hovers the mouse over the position between clip 214 and clip 216, a space 500 between clip 214 and clip 216 in timeline 218 will grow to a width that corresponds to the total duration of clip 206 and clip 210 thereby giving the user a sense of how long the two clips are relative to clip 214 and clip 216. Growing the space may be done by a gradual widening of the space between two clips in the timeline. In other words, growing the space may be performed by gradually moving two adjacent clips in the timeline apart to create a distance between the two clips that corresponds to the total duration of the video clips in the preview sequence.

FIG. 5B illustrates inserting selected video clips into a new position in the timeline 218. For example, preview sequence 400 that includes clips 206 and 210 may be dragged into timeline 218 using cursor 300 and dropped between clip 214 and clip 216. When dropped, clips 206 and 210 may be moved from their previous positions in timeline 218 to a new position between clip 214 and clip 216 in timeline 218. Thus, a user may use cursor 300 to cause a drag-and-drop operation to be performed by the video editing application that changes the order of the video clips 204-216 in the video clip sequence displayed in timeline 218.

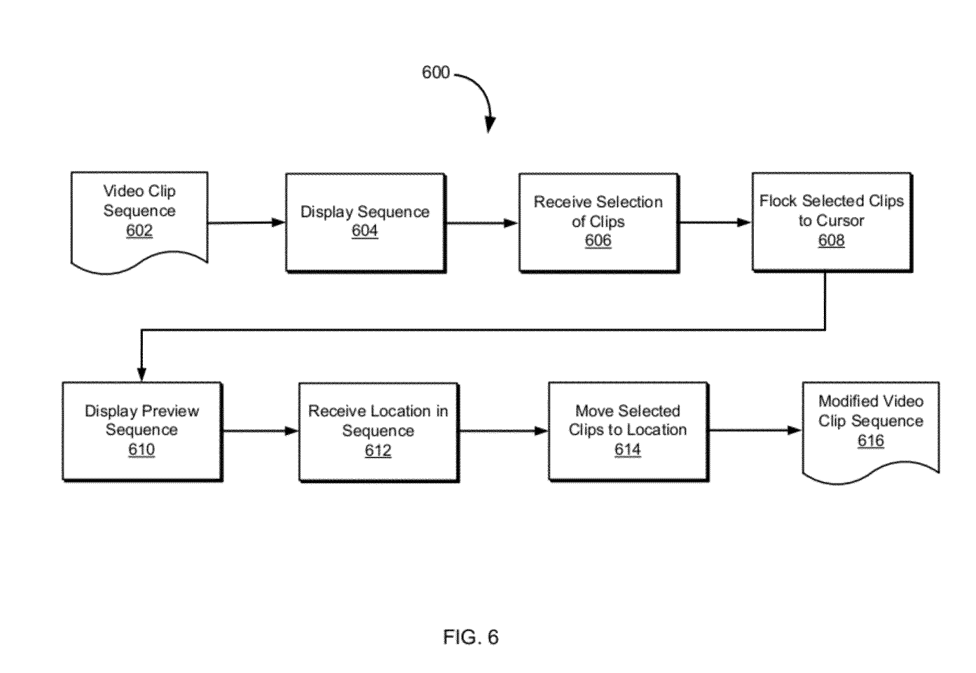

FIG. 6 is a block diagram of an exemplary video clip flocking system. The video clip flocking system allows a user to manipulate images corresponding to one or more video clips in order to modify a sequence of video clips being edited in the system. The system is configured to perform operations on video clip sequence 602. For example, video clip sequence 602 may include video clips from a single video or may include video clips from several different videos that a user wishes to combine into a single video using the exemplary system.

In block 604, the video clip sequence is displayed. For example, the video clip sequence may be displayed on a timeline, such as timeline 218 of FIG. 2, on a user interface of a video editing application. The timeline may indicate a present order of the video clips in the sequence. The timeline may also indicate the duration of each video clip and/or the duration of the sequence of video clips.

In block 606, a selection of video clips is received. For example, a user may select one or more video clips displayed in the timeline. The clips may be adjacent or non-adjacent clips. For example, multiple non-adjacent clips may be selected.

In block 608, the selected clips are flocked to the cursor. Flocking may be initiated by dragging one of the selected clips from the timeline. For example, in FIG. 4, if clips 206 and 210 are selected and clip 210 is dragged from the timeline, clips 206 and 210 may flock to the location of the cursor. Once the clips are dragged from the timeline, the timeline may display empty spaces at the locations in the timeline from which the clips were dragged. Alternatively, the timeline may continue to display the images of the selected clips after the clips are dragged from the timeline. If non-adjacent clips are selected, each clip may take a different respective path from their respective locations in the timeline to the cursor location. For example, images representing each clip may be displayed in the timeline. Multiple non-adjacent clips may be selected and dragged to a location on the display using the cursor. When dragged, the images of the selected clips may move along respective paths to the location of the cursor, as illustrated by FIG. 4. If adjacent clips are selected from the timeline, the adjacent clips may be treated as a single clip as they move from the timeline to the cursor location.

In block 610, a preview sequence of the selected clips is displayed. For example, once the selected clips have flocked to the cursor location, a preview sequence of the selected clips may be displayed. The preview sequence may display images corresponding to the selected clips in the same respective order as they were displayed in the timeline. The preview sequence may be moved around the display as if the sequence was a single clip. For example, a user may use the cursor to move the preview sequence around the display. Allowing the preview sequence to be manipulated in this way may allow drag-and-drop operations to be performed on the video clips in the preview sequence.

The preview sequence of video clips may be held at the cursor until released. For example, a user may select multiple clips from the timeline and click and hold a mouse button down to drag the clips from the timeline. While the user continues to hold the mouse button down, a preview sequence may continue to be displayed at the location of the cursor. If the user releases the mouse button at a location other than the timeline or if the user cancels the preview by pressing a keyboard key (e.g., Esc or Backspace keys), the preview sequence may be released causing the images of the video clips in the preview sequence to return to the timeline without changing the timeline. For example, when a cancel event is received (e.g., the preview is canceled or released) a reverse flocking animation may be performed in which the video clip images in the preview sequence may be shown or animated to move back to their original positions in the timeline from the video clip preview. When the preview sequence is released, the images may be displayed moving back to the timeline from the cursor location along respective paths. Once the images have reached the timeline, the video clip images may occupy empty spaces in the timeline that were created when the video clip images were dragged from the timeline.

In block 612, a location in the sequence of clips in the timeline is received. For example, a user may move the preview sequence of video clips as if the sequence was a single clip to a location in the timeline. The user may hover the preview sequence over the location. For example, a user may hold a mouse button down while dragging the preview sequence to the location in the timeline and hover the preview sequence over the location by continuing to hold the mouse button down while the preview sequence is held over the location. While hovering the preview sequence over the location in the timeline, the video clips in the timeline near the location may move to grow a space in the timeline having a width that corresponds to the total duration of the video clips in the preview sequence, as illustrated by FIG. 5A.

In block 614, the selected clips are moved to the location in the timeline. For example, the preview sequence (sequence of images of selected clips) may be dragged to a location in the timeline and dropped (mouse button released) into the timeline at the location. When the preview sequence is dropped into the location in the timeline, the images of the selected clips may be inserted at the drop location in the timeline. Dropping the preview sequence into the timeline at the location may cause the sequence of video clips in the timeline to be modified. The modified sequence of video clips in the timeline may be generated by moving the selected video clips from their previous locations in the timeline to a new location in the timeline corresponding to the location in the timeline where the preview sequence was dropped. Thus, the system may generate and display a modified sequence of images in the timeline and generate a modified sequence of video clips 616 that corresponds to the modified sequence of images.

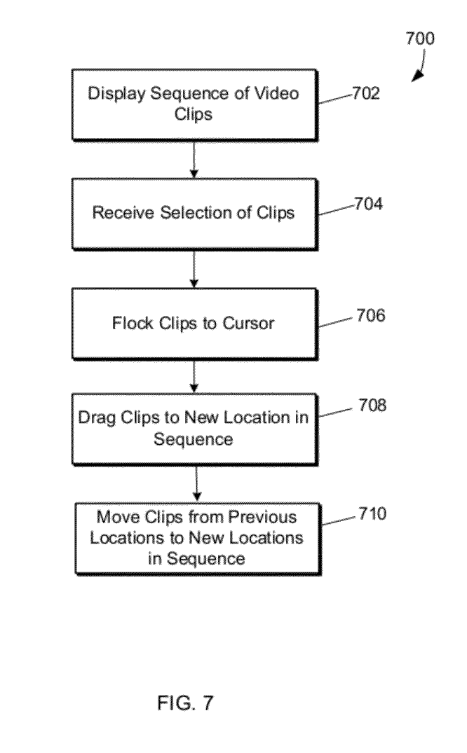

FIG. 7 is a flow diagram of an exemplary video clip flocking process. At step 702, a sequence of video clips is displayed. For example, the sequence of video clips may be displayed in the manner disclosed in the descriptions of FIG. 2 and FIG. 6, above.

At step 704, a selection of video clips is received. For example, a selection of video clips may be received in the manner disclosed in the description of FIG. 3 and FIG. 6, above.

At step 706, the selected video clips are flocked to a cursor. For example, the selected video clips may be flocked to the cursor in the manner disclosed in the description of FIG. 4 and FIG. 6, above.

At step 708, the selected video clips are dragged to a new location in the sequence. For example, the selected video clips may be dragged to a new location in the sequence in the manner disclosed in the description of FIG. 5A, FIG. 5B and FIG. 6, above.

At step 710, the selected video clips are moved from their previous locations in the sequence to new locations in the sequence. For example, the selected video clips may be moved in the sequence in the manner disclosed in the description of FIG. 5A, FIG. 5B and block 614 of FIG. 6, above.

### Exemplary System Architecture

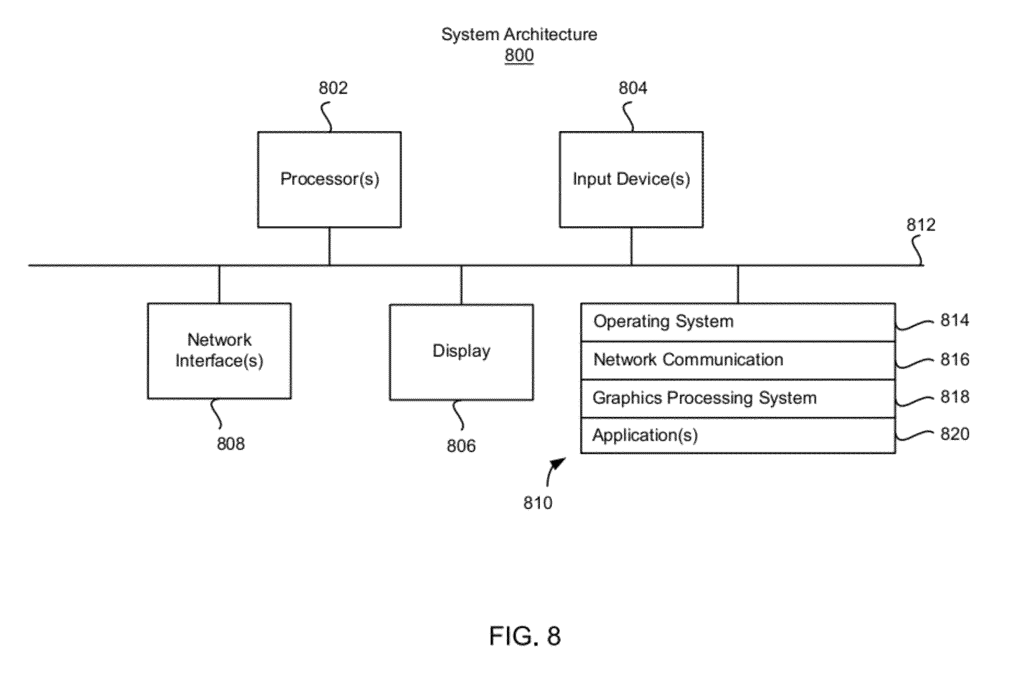

FIG. 8 is a block diagram of an exemplary system architecture implementing the features and processes of FIGS. 1-7. The architecture 800 can be implemented on any electronic device that runs software applications derived from compiled instructions, including without limitation personal computers, servers, smart phones, media players, electronic tablets, game consoles, email devices, etc. In some implementations, the architecture 800 can include one or more processors 802, one or more input devices 804, one or more display devices 806, one or more network interfaces 808 and one or more computer-readable mediums 810. Each of these components can be coupled by bus 812.

Display device 806 can be any known display technology, including but not limited to display devices using Liquid Crystal Display (LCD) or Light Emitting Diode (LED) technology. Processor(s) 802 can use any known processor technology, including but are not limited to graphics processors and multi-core processors. Input device 804 can be any known input device technology, including but not limited to a keyboard (including a virtual keyboard), mouse, track ball, and touch-sensitive pad or display. Bus 812 can be any known internal or external bus technology, including but not limited to ISA, EISA, PCI, PCI Express, NuBus, USB, Serial ATA or FireWire. Computer-readable medium 810 can be any medium that participates in providing instructions to processor(s) 802 for execution, including without limitation, non-volatile storage media (e.g., optical disks, magnetic disks, flash drives, etc.) or volatile media (e.g., SDRAM, ROM, etc.).

Computer-readable medium 810 can include various instructions 814 for implementing an operating system (e.g., Mac OS®, Windows®, Linux). The operating system can be multi-user, multiprocessing, multitasking, multithreading, real-time and the like. The operating system performs basic tasks, including but not limited to: recognizing input from input device 804; sending output to display device 806; keeping track of files and directories on computer-readable medium 810; controlling peripheral devices (e.g., disk drives, printers, etc.) which can be controlled directly or through an I/O controller; and managing traffic on bus 812. Network communications instructions 816 can establish and maintain network connections (e.g., software for implementing communication protocols, such as TCP/IP, HTTP, Ethernet, etc.).

A graphics processing system 818 can include instructions that provide graphics and image processing capabilities. For example, the graphics processing system 818 can implement the video clip flocking processes, as described with reference to FIGS. 1-7.

Application(s) 820 can be an image processing application or any other application that uses the video clip flocking processes described in reference to FIGS. 1-7, such as a photo or video editor. The video clip flocking processes can also be implemented in operating system 814.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A method comprising:
displaying a first sequence of objects on a display of a computing device;
receiving a selection of at least two non-adjacent objects from the first sequence; and
animating the at least two non-adjacent objects to move along respective paths from the display of the first sequence to a current location of a cursor on the display.

2. The method of claim 1, further comprising:
displaying a preview sequence of the at least two non-adjacent objects at the current location of the cursor.

3. The method of claim 2, further comprising:
while moving a cursor on the display, moving the preview sequence proximate to the cursor.

4. The method of claim 2, wherein the at least two non-adjacent objects are displayed in the preview sequence contiguously and in the same relative order as they were displayed in the first sequence.

5. The method of claim 1, comprising:
receiving input indicating a position in the first sequence; and
moving the at least two non-adjacent objects to the position in the first sequence to change the order of the objects in the first sequence;
displaying the changed first sequence of objects.

6. The method of claim 1, further comprising:
performing a drag operation that causes two or more images corresponding to the at least two non-adjacent objects in the first sequence to move from the display of the first sequence to the current location of the cursor on the display.

7. The method of claim 1, further comprising:
performing a drag-and-drop operation that causes two or more images corresponding to the at least two non-adjacent objects displayed at the current location of the cursor to move from the current location of the cursor to an indicated location in the first sequence and that causes moving the at least two non-adjacent objects from their previous locations in the first sequence to adjacent positions at the indicated location in the first sequence to generate a modified first sequence.

8. The method of claim 1, wherein the first sequence of objects comprises video clips.

9. The method of claim 2, further comprising:
receiving input that causes displaying the cursor and the preview sequence hovering over a position in the first sequence;
responsive to the input, displaying an empty space at the position in the first sequence, the empty space having a width that corresponds to a length of the preview sequence.

10. A system comprising:
a display;
at least one processor;
a computer-readable storage medium storing one or more sequences of instructions which, when executed by the at least one processor, causes:
displaying a first sequence of video clips on a display of a computing device;
receiving a selection of at least two non-adjacent video clips from the first sequence; and
animating the at least two non-adjacent video clips to move along respective paths from the display of the first sequence to a current location of a cursor on the display.

11. The system of claim 10, wherein the instructions comprise instructions that cause:
displaying a preview sequence of the at least two non-adjacent video clips at the current location of the cursor.

12. The system of claim 11, wherein the instructions comprise instructions that cause:
while moving a cursor on the display, moving the preview sequence proximate to the cursor.

13. The system of claim 11, wherein the at least two non-adjacent video clips are displayed in the preview sequence contiguously and in the same relative order as they were displayed in the first sequence.

14. The system of claim 10, wherein the instructions comprise instructions that cause:
receiving input indicating a position in the first sequence; and
moving the at least two non-adjacent video clips to the position in the first sequence to change the order of the video clips in the first sequence;
displaying the changed first sequence of video clips.

15. The system of claim 10, wherein the instructions comprise instructions that cause:
performing a drag operation that causes two or more images corresponding to the at least two non-adjacent video clips in the first sequence to move from the display of the first sequence to the current location of the cursor on the display.

16. The system of claim 10, wherein the instructions comprise instructions that cause:
performing a drag-and-drop operation that causes two or more images corresponding to the at least two non-adjacent video clips displayed at the current location of the cursor to move from the current location of the cursor to an indicated location in the first sequence and that causes moving the at least two non-adjacent video clips from their previous locations in the first sequence to adjacent positions at the indicated location in the first sequence to generate a modified first sequence.

17. The system of claim 11, wherein the instructions comprise instructions that cause:
receiving input that causes displaying the cursor and the preview sequence hovering over a position in the first sequence;
responsive to the input, displaying an empty space at the position in the first sequence, the empty space having a width that corresponds to a duration of the preview sequence of video clips.

18. A non-transitory computer-readable storage medium storing one or more sequences of instructions which, when executed by one or more processors, causes:
displaying a first sequence of objects on a display of a computing device;
receiving a selection of at least two non-adjacent objects from the first sequence; and
animating the at least two non-adjacent objects to move along respective paths from the display of the first sequence to a current location of a cursor on the display.

19. The non-transitory computer-readable storage medium of claim 18, wherein the instructions comprise instructions that cause:
displaying a preview sequence of the at least two non-adjacent objects at the current location of the cursor.

20. The non-transitory computer-readable storage medium of claim 19, wherein the instructions comprise instructions that cause:
while moving a cursor on the display, moving the preview sequence proximate to the cursor.

21. The non-transitory computer-readable storage medium of claim 19, wherein the at least two non-adjacent objects are displayed in the preview sequence contiguously and in the same relative order as they were displayed in the first sequence.

22. The non-transitory computer-readable storage medium of claim 18, wherein the instructions comprise instructions that cause:
receiving input indicating a position in the first sequence; and
moving the at least two non-adjacent objects to the position in the first sequence to change the order of the objects in the first sequence;
displaying the changed first sequence of objects.

23. The non-transitory computer-readable storage medium of claim 18, wherein the first sequence of objects comprises video clips.

24. The non-transitory computer-readable storage medium of claim 19, wherein the instructions comprise instructions that cause:
receiving input that causes displaying the cursor and the preview sequence hovering over a position in the first sequence;
responsive to the input, displaying an empty space at the position in the first sequence, the empty space having a width that corresponds to a length of the preview sequence.
